(19) United States
(12) Patent Application Publication
(10) Pub. No.: US 2013/0198399 A1
(43) Pub. Date: Aug. 1, 2013

(54) INPUT/OUTPUT COMMUNICATION

(71) Applicant: Matt A. Torres, Salem, OR (US)

(72) Inventor: Matt A. Torres, Salem, OR (US)

(73) Assignee: Hewlett-Packard Development Company, L.P., Fort Collins, CO (US)

(21) Appl. No.: 13/878,560

(22) PCT Filed: Oct. 15, 2010
(86) PCT No.: PCT/US2010/052871

§ 371 Date: Apr. 9, 2013

(51) Int. Cl. H04L 29/06

(52) U.S. Cl. CPC H04L 65/1009
USPC 709/228

(57) ABSTRACT

Data (e.g., a media stream) is received from a first electronic device at a second electronic device. Input is extracted from the received data. Thereafter, output responsive to the input is transmitted from the second electronic device to the first electronic device.

### BACKGROUND

An electronic device may be configured to transmit video content to and/or receive video content from another electronic device. Such exchanges of video content may enable a wide range of applications. For example, the ability of two electronic devices to exchange video content may enable videoconferencing.

### SUMMARY

According to one general aspect, a communications session is established between a first computing system and a second, physically distinct, and remote computing system according to a communications protocol that enables exchange of video content. Data (e.g., of a first content type), including application input (e.g., of a second content type), is received at the second computing system from the first computing system and within the established communications session. The application input is extracted from the received data and passed to an application. Application output that is responsive to the passed application input then is received from the application to which the extracted application input was passed. Thereafter, at least some of the application output is transmitted from the second computing system to the first computing system as video content within the established communications session.

Implementations may include one or more of the following features. For instance, the communications protocol may enable the exchange of video content and audio content.

In one example, a session initiation protocol (SP) communications session may be established between the first computing system and the second computing system such that receiving data, including application input, from the first computing system at the second computing system and within the established communications session includes receiving data, including application input, from the first computing system at the second computing system within the established SIP communications session, and transmitting at least some of the application output as video content from the second computing system to the first computing system within the established communications session includes transmitting at least some of the application output as video content from the second computing system to the first computing system within the established SIP communications session. Furthermore, the application input may be keyboard and/or pointing device (e.g., computer mouse) input. Therefore, keyboard and/or pointing device (e.g., computer mouse) input may be received from the first computing system at the second computing system within the established SIP communications session and extracted from data received within the established SIP communications session. In addition, the extracted input from the keyboard and/or pointing device (e.g., computer mouse) may be passed to the application, and application output that is responsive to the passed keyboard and/or pointing device (e.g., computer mouse) input may be received.

In another example, an H.323 communications session may be established between the first computing system and the second computing system such that receiving data, including application input, from the first computing system at the second computing system and within the established communications session includes receiving data, including application input, from the first computing system at the second computing system within the established H.323 communications session, and transmitting at least some of the application output as video content from the second computing system to the first computing system within the established communications session includes transmitting at least some of the application output as video content from the second computing system to the first computing system within the established H.323 communications session.

Continuing with the example of the H.323 communications session established between the first computing system and the second computing system, the application input may be keyboard and/or pointing device (e.g., computer mouse) input. Therefore, keyboard and/or pointing device (e.g., computer mouse) input may be received from the first computing system at the second computing system within the established H.323 communications session and extracted from data received within the established H.323 communications session. In addition, the extracted input from the keyboard and/or pointing device (e.g., computer mouse) may be passed to the application, and application output that is responsive to the passed keyboard and/or pointing device (e.g., computer mouse) input may be received.

Furthermore, in some implementations, the data received from the first computing system at the second computing system within the established H.323 communications session may include audio-video (NV) content. For example, in some implementations, an audio signal and a corresponding video signal, within which the application input is embedded, may be received from the first computing system at the second computing system within the established H.323 communications session. In such implementations, the application input may be extracted from the video signal. Alternatively, a T.120 stream, within which the application input is embedded, may be received within the established H.323 communications session, and the application input may be extracted from the T.120 stream. As another alternative, dual-tone multi-frequency (DTMF) tones onto which the application input has been mapped in-band with the AN content may be received within the established H.323 communications session, and the received DTMF tones may be converted into the application input. As yet another alternative, first and second channels between the first computing system and the second computing system may be established within the H.323 communications session, and A/V content may be received from the first computing system at the second computing system over the first channel within the established H.323 communications session, and DTMF tones onto which the application input has been mapped may be received from the first computing system at the second computing system over the second channel within the established H.323 communications session. The received DTMF tones then may be converted into the application input.

According to another general aspect, a request to establish a communications session according to a communications protocol that enables the exchange of audio-video (A/V) content is received from a physically distinct electronic device over a first network connection to the electronic device. Responsive to receiving the request to establish a communications session, a communications session is established with the electronic device over the first network connection according to the communications protocol that enables the exchange of A/V content. Data, including application input signals from a keyboard, then is received from the electronic device over the first network connection to the electronic device within the established communications session with the electronic device, the received data including application input signals from a keyboard. The application input signals from the keyboard are extracted from the received data, the extracted application input signals from the keyboard are determined to correspond to an application hosted by a physically distinct computing system that is different from the electronic device, and, as a consequence of having determined that the extracted application input signals from the keyboard correspond to the application hosted by computing system, the extracted application input signals from the keyboard are transmitted to the computing system over a second network connection to the computing system that is different from the first network connection. Thereafter, application output that is responsive to the transmitted application input signals from the keyboard is received from the application hosted by the computing system over the second network connection to the computing system. The received application output then is converted into a video stream which is transmitted to the electronic device over the first network connection to the electronic device within the established communications session with the electronic device.

According to yet another general aspect, a graphical user interface that enables interaction with a computing system is accessed and a video stream representation of the graphical user interface is generated. The video stream representation of the graphical user interface then is transmitted from the computing system to an electronic device that is physically distinct from the computing system. A media stream having embedded therein user input received from at least one of a keyboard communicatively coupled to the electronic device and a computer mouse communicatively coupled to the electronic device is received at the computing system from the electronic device. The user input then is extracted from the received media stream and provided to the computing system as input. Thereafter, the video stream representation of the graphical user interface is modified to reflect a change to the graphical user interface that resulted from the user input being provided to the computing system as input, and the modified video stream representation of the graphical user interface reflecting the change to the graphical user interface is transmitted to the electronic device.

The various aspects, implementations, and features disclosed may be implemented using, for example, one or more of a method; an apparatus; a system; an apparatus, system, tool, or processing device for performing a method; a computer program or other set of instructions stored on a tangible computer-readable storage medium; and an apparatus that includes a program or a set of instructions stored on a computer-readable storage medium.

### BRIEF DESCRIPTION OF THE DRAWINGS

FIGS. 1A-1D are diagrams of an example of a videoconferencing endpoint.

FIGS. 2-5 are diagrams of examples of communications systems.

FIGS. 6A-6B illustrate a flow diagram of an example of a process for exchanging application input/output within a multi-media communications session.

FIG. 7 is a diagram of an example of a tablet computer accessing a remote desktop application made available by another computing device through a multi-media communications session.

### DETAILED DESCRIPTION

An electronic device establishes a multi-media communications session with one or more other electronic devices that enables the electronic devices to exchange video content with the other electronic device(s). In addition, the electronic device is configured to incorporate input received at the electronic device, for instance, from a keyboard and/or a pointing device (e.g., a computer mouse), into such a multi-media communications session thereby enabling the input received at the electronic device to be communicated to one or more of the other electronic devices within the established multi-media communications session.

In one particular example, a videoconferencing endpoint is configured to establish H.323 communications sessions with one or more other videoconferencing endpoints as well as, perhaps, one or more intermediary or coordinating devices (e.g., a multipoint control unit (MCU)) for the purpose of enabling videoconferencing between the various videoconferencing endpoints. In addition, the videoconferencing endpoint also is configured to incorporate input received from a keyboard and/or a computer mouse at the videoconferencing input into the H.323 communications sessions such that the received keyboard and/or mouse input can be communicated to one or more of the various other videoconferencing endpoints and intermediary or coordinating devices.

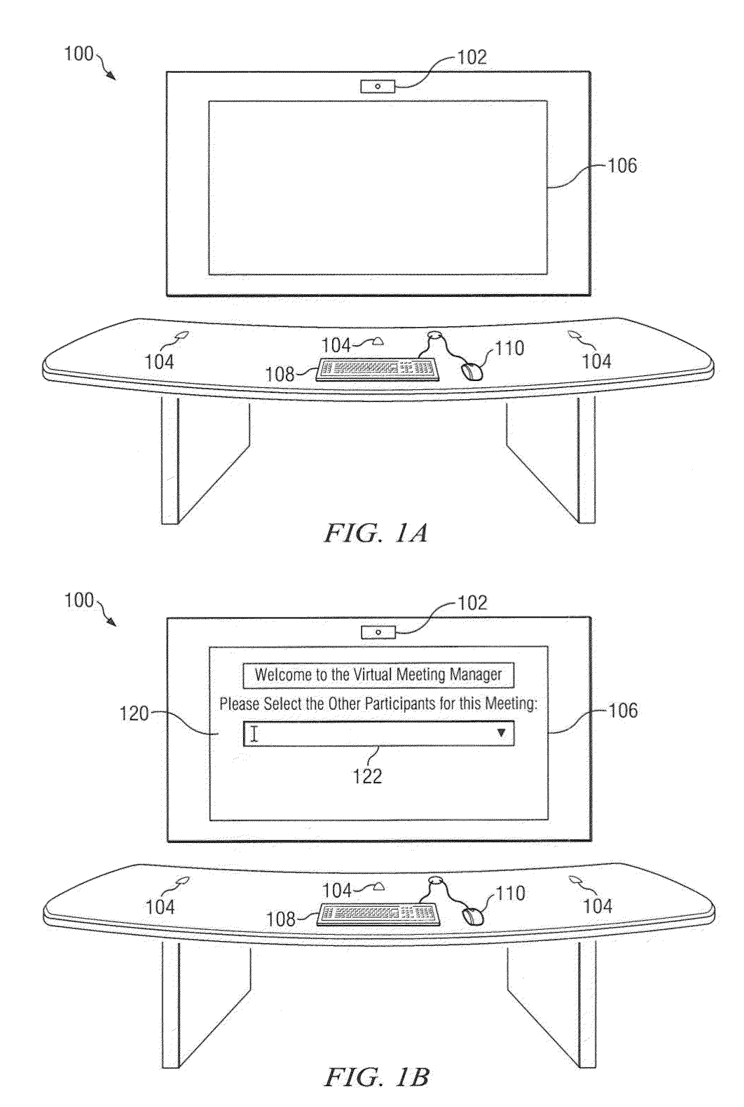

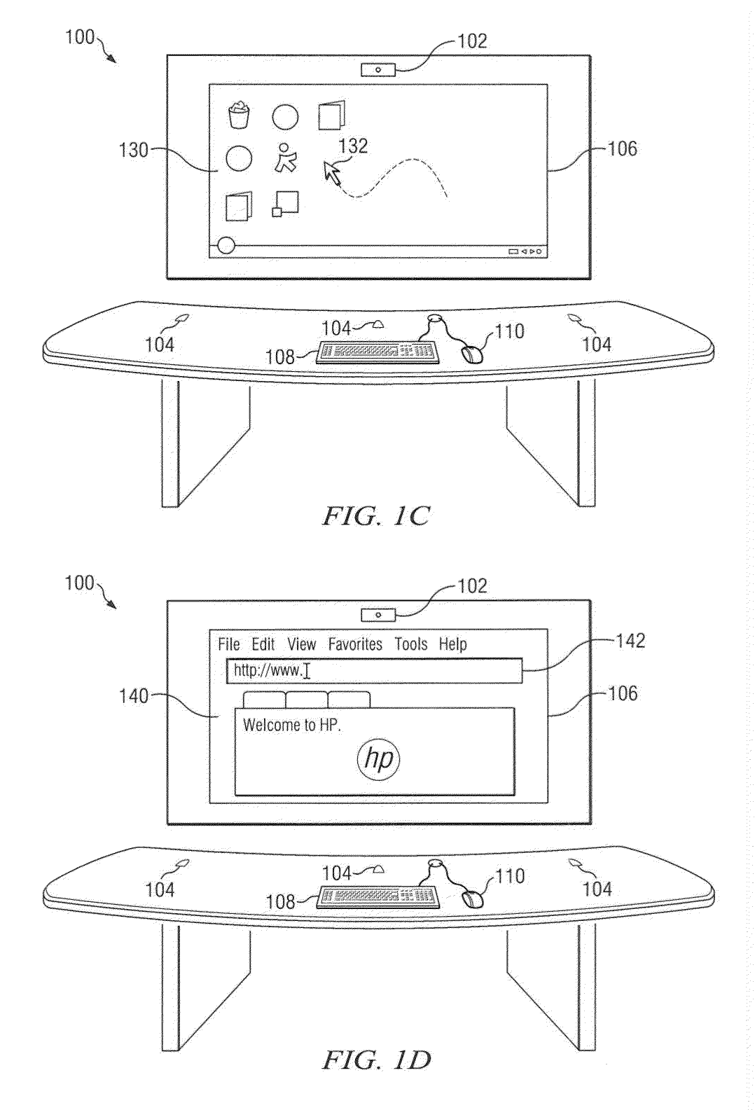

FIGS. 1A-1D are diagrams of an example of a videoconferencing endpoint 100. In this particular example, the videoconferencing endpoint 100 is a dedicated videoconferencing studio. However, other implementations of videoconferencing endpoints are possible. For example, in some implementations, a general purpose computing device (e.g., a desktop, laptop, netbook, or tablet computer, or a smartphone) may be configured as a videoconferencing endpoint. As illustrated in FIG. 1A, the videoconferencing endpoint 100 includes one or more cameras 102 and one or more microphones 104 for capturing video images of and audio from videoconferencing participants using the videoconferencing endpoint 100. In addition, the videoconferencing endpoint 100 includes one or more displays 106 for displaying received video content and one or more speakers (not shown) for rendering received audio content.

The videoconferencing endpoint 100 is configured to transmit the video and audio captured by the camera(s) 102 and microphone(s) 104, respectively, to one or more other videoconferencing endpoints. In addition, the videoconferencing endpoint 100 is configured to receive video and audio from these other videoconferencing endpoints and to display the received video on display(s) 106 and to render the received audio with the speaker(s). For example, the camera(s) 102, microphone(s) 104, display(s) 106, and speaker(s) may be communicatively coupled to one or more computing devices (e.g., one or more routers and codecs) (not shown) that are located at the videoconferencing endpoint 100 and that are configured to orchestrate the exchange of video and audio content as well as control and signaling data with the other videoconferencing endpoints and, perhaps, with one or more intermediary or coordinating devices (e.g., servers, routers, gateways, and/or an MCU). In this manner, the videoconferencing endpoint 100 enables videoconferencing participants using videoconferencing endpoint 100 to engage in a videoconference with other videoconferencing participant. Either of or both point-to-point and multi-point videoconferencing may be supported by videoconferencing endpoint 100.

Different schemes may be employed to enable the exchange of video and audio content between videoconferencing endpoint 100 and other videoconferencing endpoints to enable videoconferencing between the various different videoconferencing endpoints. For example, in one implementation, the videoconferencing endpoints may be configured as H.323 nodes that employ the International Telecommunications Union (ITU) Telecommunication Standardization Sector's (ITU-T) H.323 standard for providing audio-video communication sessions in order to exchange audio-video streams to enable videoconferencing. Alternatively, the videoconferencing endpoints may be configured as session initiation protocol (SIP) nodes that employ the Internet Engineering Task Force's (IETF) SIP protocol for controlling multi-media communication sessions in order to exchange audio-video streams to enable videoconferencing.

Videoconferencing endpoint 100 includes a keyboard 108 and a computer mouse 110 and is configured to receive input from one or both of keyboard 108 and computer mouse 110. For example, keyboard 108 and computer mouse 110 may be communicatively coupled to the one or more computing devices (not shown) that are located at the videoconferencing endpoint 100 and that are configured to orchestrate the exchange of video and audio content as well as control and signaling data with the other videoconferencing endpoints and, perhaps, with one or more intermediary or coordinating devices (e.g., servers, routers, gateways, and/or an MCU). In some implementations, the video input card (not shown) that receives video input from camera(s) 102 for transmission to other videoconferencing endpoints may be configured to receive keyboard 108 and/or computer mouse 110 input and to encode such keyboard 108 and/or computer mouse 110 data into the video streams that get transmitted upstream.

Videoconferencing endpoint 100 is configured to transmit input received from keyboard 108 and/or computer mouse 110 upstream to the other videoconferencing endpoints and/or intermediary or coordinating devices within multi-media communications sessions that have been established with such other devices. For example, videoconferencing endpoint 100 may incorporate input received from keyboard 108 and/or computer mouse 110 into audio-video streams communicated upstream by videoconferencing endpoint 100 to the other videoconferencing endpoints and/or intermediary or coordinating devices. In addition, videoconferencing endpoint 100 may be configured to receive, within such established multi-media communications sessions, output that is responsive to the input received from keyboard 108 and/or computer mouse 110 that the other videoconferencing endpoint 100 transmitted upstream from the other videoconferencing endpoint or intermediary or coordinating device to which the videoconferencing endpoint 100 initially transmitted the keyboard 108 and/or computer mouse 110 input.

As discussed above, in one specific example, videoconferencing endpoint 100 may be configured as an H.323 node that exchanges audio-video streams with other videoconferencing endpoints and/or intermediary or coordinating devices via H.323 multi-media communications sessions. According to this example, videoconferencing endpoint 100 is configured to transmit input received from keyboard 108 and/or computer mouse 110 upstream by incorporating such input within the H.323 multi-media communications sessions. A number of different techniques may be employed to incorporate input received from keyboard 108 and/or computer mouse 110 into the H.323 multi-media communications sessions. In one implementation, input received from keyboard 108 and/or computer mouse 110 may be encoded within the video signal or the audio signal communicated within the H.323 videoconferencing communications session. In another implementation, input received from keyboard 108 and/or computer mouse 110 may be encoded within a T.120 stream communicated within the H.323 videoconferencing communications session. Alternatively, in still other implementations, input received from keyboard 108 and/or computer mouse 110 may be mapped onto in-band (or out-of-band) dual-tone multi-frequency (DTMF) tones communicated within the H.323 videoconferencing communications session.

In another example, videoconferencing endpoint 100 may be configured as a SIP node that exchanges audio-video streams with other videoconferencing endpoints and/or intermediary or coordinating devices via SIP multi-media communications sessions. According to this example, videoconferencing endpoint 100 is configured to transmit input received from keyboard 108 and/or computer mouse 110 upstream by incorporating such input within the SIP multi-media communications sessions.

The ability of videoconferencing endpoint 100 to receive input from keyboard 108 and/or computer mouse 110, to transmit such received input to other videoconferencing endpoints and/or intermediary or coordinating devices within established multi-media communications sessions, and to receive responsive output within such established multi-media communications sessions may enable videoconferencing endpoint 100 to provide increased functionality to a user of videoconferencing endpoint 100 that videoconferencing endpoint 100 otherwise may not be able to provide. For example, such capability may enable videoconferencing endpoint 100 to transmit input received from keyboard 108 and/or computer mouse 110 to an application executing on an upstream server or other computing device that is remote from videoconferencing endpoint 100. In addition, responsive to transmitting such input received from keyboard 108 and/or computer mouse 110 to the application executing on the remote server or other computing device, videoconferencing endpoint 100 may receive and render output from the application at videoconferencing endpoint 100. In this manner, videoconferencing endpoint 100 may enable a user of videoconferencing endpoint 100 to use keyboard 108 and/or computer mouse 110 to interact with an application executing on a remote server or other computing device.

Referring now to FIG. 1B, in one example, videoconferencing endpoint 100 enables a user of videoconferencing endpoint 100 to use keyboard 108 and/or computer mouse 110 to interact with a graphical user interface (GUI) 120 provided by a videoconferencing management application executing on a server or other computing device that is remote from videoconferencing endpoint 100. More particularly, as illustrated in FIG. 1B, the GUI 120 provided by the videoconferencing management application executing on the remote server or other computing device enables a user to connect videoconferencing endpoint 100 to other videoconferencing endpoints. The user of videoconferencing endpoint 100 may manipulate the GUI, for example, by using keyboard 108 to enter textual input in dropdown menu 122 or by using computer mouse 110 to pull down dropdown menu 122 to expose predefined connection options.

In another example, referring to FIG. 1C, videoconferencing endpoint 100 may provide a user with access to a remote desktop interface 130 to a computer that is remote from videoconferencing endpoint 100 and with which videoconferencing endpoint 100 has established a multi-media communications session, thereby making available to the user of videoconferencing endpoint 100 applications to which the remote computer has access. In particular, the remote desktop interface 130 may be converted into a video stream that is communicated to videoconferencing endpoint 100 within the multi-media communications session established between the remote computer and videoconferencing endpoint 100. Furthermore, by incorporating input received from keyboard 108 and/or computer mouse 110 into the multi-media communications session established with the remote computer, videoconferencing endpoint 100 enables a user of videoconferencing endpoint 100 to manipulate the remote desktop interface 130 to the remote computer and to interact with applications accessible to the remote computer. For instance, as illustrated in FIG. 1C, a user of videoconferencing endpoint 100 may use computer mouse 110 to manipulate mouse pointer 132 across remote desktop interface 130.

In still another example, referring to FIG. 1D, videoconferencing endpoint 100 may establish a multi-media communications session with a remote computing device having a web browser application and access to one or more websites. When the remote computing device executes the web browser application, the web browser GUI 106 may be converted into a video stream that is communicated to videoconferencing endpoint 100 within the multi-media communications session established between the remote computing device and videoconferencing endpoint 100 and displayed on display(s) 106 of videoconferencing endpoint 100. By incorporating input received from keyboard 108 and/or computer mouse 110 into the multi-media communications session established with the remote computing device, videoconferencing endpoint 100 enables a user of videoconferencing endpoint 100 to manipulate the web browser GUI 140 to browse the websites to which the remote computer has access. For instance, as illustrated in FIG. 1D, a user of videoconferencing endpoint 100 may use keyboard 108 to enter a web address in the web address field of the web browser GUI 140.

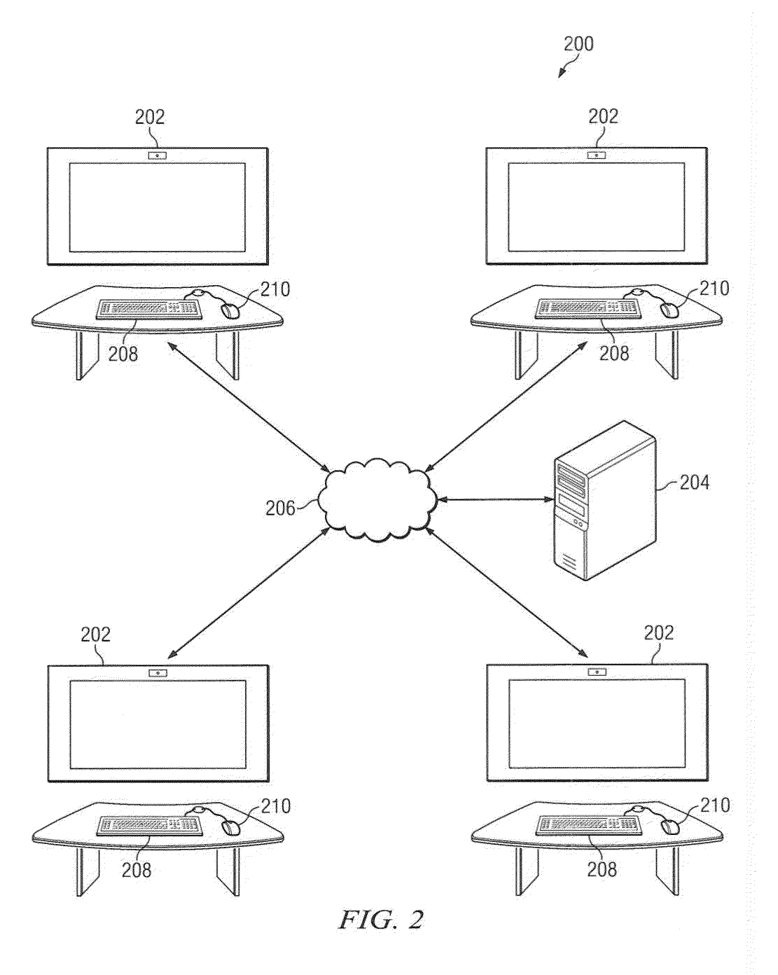

FIG. 2 is a diagram of an example of a communications system 200 capable of supporting videoconferencing. As illustrated in FIG. 2, communications system 200 includes a number of videoconferencing endpoints 202, such as, for example, videoconferencing endpoints like the videoconferencing endpoint 100 illustrated in FIG. 1, and a centralized videoconferencing management system 204, including, for example, an MCU, communicatively coupled to each of the videoconferencing endpoints 202 over network 206.

Network 206 may provide direct or indirect communication links between videoconferencing endpoints 202 and videoconferencing management system 204 irrespective of physical separation between any of such devices. As such, videoconferencing management system 204 and any of videoconferencing endpoints 202 may be located in close geographic proximity to one another or, alternatively, videoconferencing management system 204 and videoconferencing endpoints 202 may be separated by vast geographic distances. Examples of network 206 include a corporate intranet, an enterprise network, a dedicated videoconferencing network, the Internet, the World Wide Web, wide area networks (WANs), local area networks (LANs) including wireless LANs (WLANs), analog or digital wired and wireless telephone networks, radio, television, cable, satellite, any other delivery mechanisms for carrying data, and/or any combination thereof.

Videoconferencing endpoints 202 access videoconferencing management system 204 via network 206 and coordinate with videoconferencing management system 204 to establish and maintain multi-media communication sessions with other of the videoconferencing endpoints 202. After such multi-media communications sessions have been established between the videoconferencing endpoints 202, the videoconferencing endpoints 202 can exchange audio-video streams within the multi-media communications sessions, thereby enabling videoconferencing between the videoconferencing endpoints 202. For example, an individual videoconferencing endpoint 202 may call the videoconferencing management system 204 and establish a multi-media communications session with the videoconferencing management system 204. Thereafter, the videoconferencing endpoint 202 and the videoconferencing management system 204 may coordinate to connect the videoconferencing endpoint 202 with one or more of the other videoconferencing endpoints 202 in order to establish a videoconference between the videoconferencing endpoints 202.

In some implementations, videoconferencing endpoints 202 and videoconferencing management system 204 may be configured as H.323 nodes and multi-media communications sessions established between videoconferencing endpoints 202 and/or videoconferencing management system 204 may be established according to the H.323 standard. Alternatively, in other implementations, videoconferencing endpoints 202 and videoconferencing management system 204 may be configured as SIP nodes and multi-media communications sessions established between videoconferencing endpoints 202 and/or videoconferencing management system 204 may be established according to the SIP standard

Each videoconference endpoint 202 includes a keyboard 208 and a computer mouse 210 from which the videoconference endpoint 202 is configured to receive input. In addition, each videoconference endpoint 202 is configured to be able to incorporate input received from keyboard 208 and/or computer mouse 210 into a multi-media communications session established between the videoconferencing endpoint 202 and any other computing device. Therefore, the videoconferencing endpoint 202 may be capable of transmitting input received from keyboard 208 and/or mouse 210 to any other computing device that the videoconferencing endpoint 202 can call to establish a multi-media communications session, including, for example, videoconferencing management system 204.

When videoconferencing endpoints 202 and videoconferencing management system 204 are configured as H.323 nodes, each videoconference endpoint 202 may be configured to be able to incorporate input received from keyboard 208 and/or mouse 210 into H.323 communications sessions established between the videoconferencing endpoint 202 and videoconferencing management system 204. Similarly, when videoconferencing endpoints 202 and videoconferencing management system 204 are configured as SIP nodes, each videoconference endpoint 202 may be configured to be able to incorporate input received from keyboard 208 and/or computer mouse 210 into SIP communications sessions established between the videoconferencing endpoint 202 and videoconferencing management system 204.

Videoconferencing management system 204 is configured to be able to extract keyboard and/or computer mouse input from multi-media communications sessions (e.g., H.323 or SIP communications sessions) established between videoconferencing management system 204 and any other device capable of incorporating keyboard and/or computer mouse data into such a multi-media communications session. Therefore, when any of the videoconferencing endpoints 202 call the videoconferencing management system 204 and establish a multi-media communications session with the videoconferencing management system 204, the videoconferencing management system 204 is capable of extracting keyboard and/or computer mouse input from the multi-media communications session established with the videoconferencing endpoint 202.

In some cases, the videoconferencing management system 204 provides the videoconferencing endpoints 202 with access to applications executing on the videoconferencing management system 202. Additionally or alternatively, the videoconferencing management system 204 may function as a proxy that provides the videoconferencing endpoints 202 with access to applications executing on one or more other computing devices (not shown).

When the videoconferencing management system 204 provides a videoconferencing endpoint 202 with access to an application executing on the videoconferencing management system 202, the videoconferencing management system 202 may convert graphical output generated by the application into a video stream that the videoconferencing management system 204 transmits to the videoconferencing endpoint 202 within the multi-media communications session (e.g., an H.323 or SIP communications session) established between videoconferencing management system 204 and the videoconferencing endpoint 202. The videoconferencing endpoint 202 then displays this video stream, thereby providing a user of the videoconferencing endpoint 202 with access to the graphical output generated by the application executing on the videoconferencing management system 204.

In order to interact with the application executing on videoconferencing management system 204 and its graphical output displayed by videoconferencing endpoint 202, a user of videoconferencing endpoint 202 may provide input using keyboard 208 and/or computer mouse 210. The videoconferencing endpoint 202 then may transmit any such input received from keyboard 208 and/or computer mouse 210 to the videoconferencing management system 204 by incorporating such input into the multi-media communications session (e.g., an H.323 or SIP communications session) established between the videoconferencing endpoint 202 and the videoconferencing management system 204.

The videoconference management system 204 is configured to extract such keyboard and/or mouse input from the multi-media communications session and to pass the extracted input to the application executing on the videoconference management system 204. Responsive to this input, the application executing on videoconferencing management system 204 may generate additional, new, or revised output, which the videoconferencing management system 204 may convert into a video stream and transmit to the videoconferencing endpoint 202 via the multi-media communications session established between the videoconferencing endpoint 202 and the videoconferencing management system 204. In this manner, the user of the videoconferencing endpoint 202 may continue to interact with and provide input to the application executing on videoconferencing management system 204 using the keyboard 208 and/or computer mouse 210 at the videoconferencing endpoint 202.

In some implementations, videoconferencing management system 204 may provide videoconferencing endpoints 202 with access to a videoconferencing management GUI configured to facilitate the scheduling and connecting of videoconferences. For example, when the videoconferencing endpoints 202 all belong to an enterprise videoconferencing solution, the videoconferencing management GUI may enable a user to browse a directory of videoconferencing participants and/or videoconference endpoints 202 in order to schedule videoconferences involving certain videoconferencing participants and/or videoconferencing endpoints 202. In such cases, a user of one of videoconferencing endpoints 202 may be able to interact with the videoconferencing management GUI made available by videoconferencing management system 204 by providing keyboard 208 and/or computer mouse 210 input that the videoconferencing endpoint 202 transmits to the videoconferencing management system 204 by incorporating it into a multi-media communications session established between the videoconferencing endpoint 202 and the videoconferencing management system 204.

In addition to (or as an alternative to) providing the videoconferencing endpoints 202 with access to applications executing on the videoconferencing management system 204, the videoconferencing management system 204 also may function as a proxy that provides the videoconferencing endpoints 202 with access to applications executing on one or more other computing devices (not shown). In such cases, the videoconferencing management system 204 may convert graphical output received from the applications executing on the other computing devices into video streams that are communicated to the videoconferencing endpoints within multi-media communication sessions established between the videoconferencing management system 204 and the videoconferencing endpoints 202. In addition, when videoconferencing management system 204 receives keyboard 208 and/or computer mouse 210 input intended for such applications executing on other computing devices from videoconferencing endpoints 202 via multi-media communications sessions established with the videoconferencing endpoints 202, the videoconferencing management system 204 extracts the keyboard 208 and/or computer mouse 210 input from the communications sessions and transmits it along to the appropriate applications executing on the other computing devices.

In one example, videoconferencing management system 204 may provide videoconferencing endpoints 202 with access to a remote desktop interface. In some implementations, such a remote desktop interface may provide access to applications on videoconferencing management system 204, while, in other implementations, the videoconferencing management system 204 may function as a proxy and the remote desktop interface may provide access to applications on a different computing device. In either case, providing videoconferencing endpoints 202 with access to a remote desktop interface and enabling input received from keyboard 208 and/or computer mouse 210 to be transmitted to the remote desktop interface by embedding such input within a multi-media communications session with videoconferencing management system 204 may be useful, especially, for instance, in a corporate or enterprise environment. For example, providing videoconferencing endpoints 202 with access to a remote desktop interface in this manner may enable any number of videoconferencing endpoints 202 (e.g., conference rooms, dedicated videoconferencing studios, etc.) on a corporate campus to provide users with access to the same applications that would be available to them on their computers at their own desks.

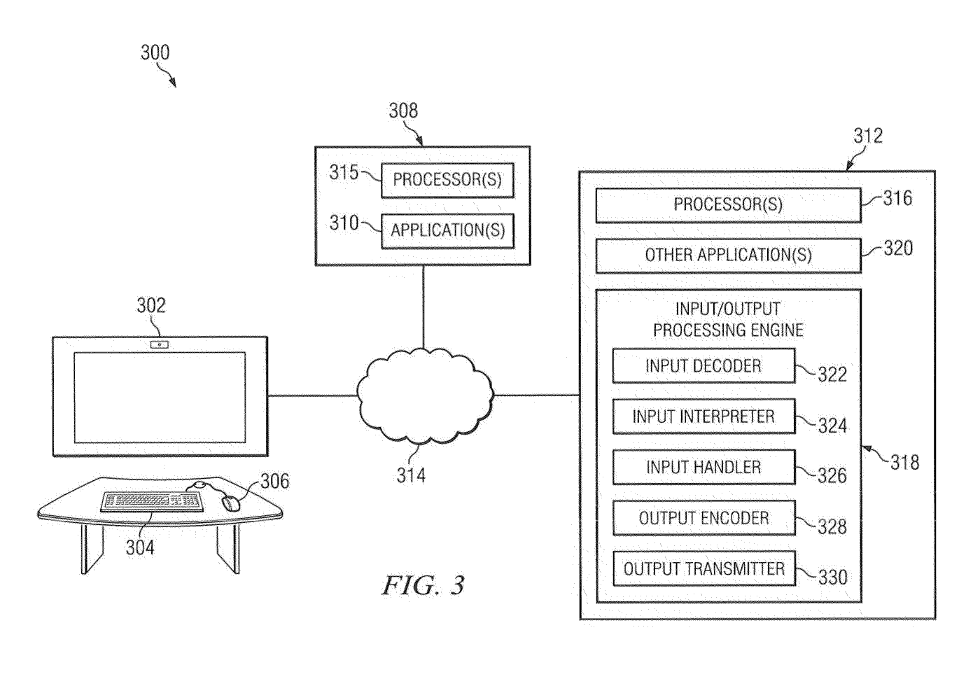

FIG. 3 is a diagram of an example of a communications system 300 that enables input received at a videoconferencing endpoint 302 from a keyboard 304 and/or computer mouse 306 to be communicated to a remote computing device 308 as input to an application 310 executing on the remote computing device 308 by incorporating the keyboard 304 and/or computer mouse 306 input into a multi-media communications session. For illustrative purposes, several elements illustrated in FIG. 3 and described below are represented as monolithic entities. However, these elements each may include and/or be implemented on numerous interconnected computing devices and other components that are designed to perform a set of specified operations and that are located proximally to one another or that are geographically displaced from one another.

As illustrated in FIG. 3, communications system 300 includes a videoconferencing endpoint 302, such as, for example, a videoconferencing endpoint like the videoconferencing endpoint 100 illustrated in FIG. 1, and computing devices 308 and 312, all of which are communicatively coupled via a network 314. Network 314 may provide direct or indirect communication links between videoconferencing endpoint 302, computing device 308, and/or computing device 312 irrespective of physical separation between any of such devices. As such, videoconferencing endpoint 302 and computing devices 308 and 312 may be located in close geographic proximity to one another or, alternatively, videoconferencing endpoint 302 and computing devices 308 and 312 may be separated by vast geographic distances. Examples of network 314 include a corporate intranet, an enterprise network, a dedicated videoconferencing network, the Internet, the World Wide Web, wide area networks (WANs), local area networks (LANs) including wireless LANs (WLANs), analog or digital wired and wireless telephone networks, radio, television, cable, satellite, any other delivery mechanisms for carrying data, and/or any combination thereof.

Videoconferencing endpoint 302 is configured to be able to establish a multi-media communications session with computing device 312 over network 314. For example, videoconferencing endpoint 302 may be configured to call computing device 312 to initiate the establishment of a multi-media communications session with computing device 312, and/or computing device 312 may be configured to call videoconferencing endpoint 302 to initiate the establishment of a multi-media communications session with videoconferencing endpoint 302. In one example, videoconferencing endpoint 302 and computing device 312 may be configured as H.323 nodes, and, as such, videoconferencing endpoint 302 and computing device 312 may establish a multi-media communications session between themselves according to the H.323 standard. Alternatively, in another example, videoconferencing endpoint 302 and computing device 312 may be configured as SIP nodes, and, as such, videoconferencing endpoint 302 and computing device 312 may establish a multi-media communications session between themselves according to the SIP standard.

Videoconferencing endpoint 302 also includes keyboard 304 and computer mouse 306 and is configured to be able to transmit input received from keyboard 304 and/or computer mouse 306 to computing device 312 by incorporating input received from keyboard 304 and/or computer mouse 306 into multi-media communications sessions established between videoconferencing endpoint 302 and computing device 312. For example, if videoconferencing endpoint 302 and computing device 312 are configured as H.323 nodes, videoconferencing endpoint 302 is configured to transmit input received from keyboard 304 and/or computer mouse 306 by incorporating input received from keyboard 304 and/or computer mouse 306 into an H.323 multi-media communications session between videoconferencing endpoint 302 and computing device 312. Similarly, if videoconferencing endpoint 302 and computing device 312 are configured as SIP nodes, videoconferencing endpoint 302 is configured to transmit input received from keyboard 304 and/or computer mouse 306 by incorporating input received from keyboard 304 and/or computer mouse 306 into an SIP multi-media communications session between videoconferencing endpoint 302 and computing device 312.

Computing devices 308 and 312 may be any of a number of different types of computing devices including, for example, a server, a personal computer, a special purpose computer, a general purpose computer, and a combination of a special purpose and a general purpose computing device. Computing devices 308 and 312 typically have internal or external storage components for storing data and programs such as an operating system and one or more application programs. Examples of application programs include authoring applications (e.g., word processing programs, database programs, spreadsheet programs, or graphics programs) capable of generating documents or other electronic content; client applications (e.g., e-mail clients) capable of communicating with other computer users, accessing various computer resources, and viewing, creating, or otherwise manipulating electronic content; and browser applications capable of rendering standard Internet content. Computing devices 308 and 312 also typically include one or more processors for executing instructions stored in storage and/or received from one or more other electronic devices, for example over network 314. In addition, computing devices 308 and 312 also usually include one or more communication devices for sending and receiving data. One example of such a communications device is a modem. Other examples include an antenna, a transceiver, a communications card, and other types of network adapters capable of transmitting and receiving data over network 314 through a wired or wireless data pathway.

Computing device 308 includes one or more processors 315 and one or more applications 310 executable on processor(s) 315 that computing device 308 makes accessible to other computing devices, for example, computing device 312, over network 314. For example, application(s) 310 may be configured to receive input (e.g., keyboard and/or mouse input) from one or more other computing devices over network 314, process such received input, generate output in response, and transmit such output to the computing device from which the input was received. Application(s) 310 may be any of a number of different applications including, for example, a remote desktop interface and one or more applications (e.g., a word processing application, a spreadsheet application, a web browser, etc.) that are accessible via the remote desktop interface; a website; and/or a data processing application. Application(s) 310 may be implemented as instructions that are stored in a computer memory storage system and that are executable by processor(s) 315 to provide the functionality ascribed herein to application(s) 310.

Computing device 312 includes one or more processors 316, input/output processing engine 318, and other application(s) 320. Input/output processing engine 318 may be implemented as instructions that are stored in a computer memory storage system and that are executable by processor(s) 316 to perform the functionality ascribed herein to the input/output processing engine 318. The input/output processing engine 318 enables computing device 312 to function as a proxy between videoconferencing endpoint 302 and one or more applications executing on one or more other computing devices, for example, application(s) 310 executing on computing device 308. In particular, input/output engine 318 enables computing device 312 to receive keyboard 304 and/or computer mouse 306 input from videoconferencing endpoint 302 within a multi-media communications session (e.g., an H.323 or SIP communications session) established between videoconferencing endpoint 302 and computing device 312, extract such keyboard 304 and/or computer mouse 306 input from the multi-media communications session, and transmit the extracted keyboard 304 and/or computer mouse 306 input as input to application(s) 310 executing on computing device 308. In addition, input/output processing engine 318 also enables computing device 312 to receive application output from application(s) 310 executing on computing device 308 and transmit such application output received from application(s) 310 to videoconferencing endpoint 302 by converting the application output into a suitable form (e.g., a video stream) and embedding the converted application output within a multimedia communications session (e.g., an H.323 or SIP communications session) established with videoconferencing endpoint 302.

More particularly, input/output processing engine 318 includes an input decoder 322, an input interpreter 324, an input handler 326, an output encoder 328, and an output transmitter 330.

When keyboard 304 and/or computer mouse 306 input is received from videoconferencing endpoint 302 within a multi-media communications session (e.g., an H.323 or SIP communications session) established with videoconferencing endpoint 302, input decoder 322 extracts the received keyboard 304 and/or computer mouse 306 input from the multi-media communications session. For example, if the keyboard 304 and/or computer mouse 306 input is encoded within a video or audio stream within the multi-media communications session, input decoder 322 decodes the keyboard 304 and/or computer mouse 306 input from the video or audio stream. Similarly, if the keyboard 304 and/or computer mouse 306 input is mapped onto in-band or out-of-band DTMF tones within the multimedia communications session, input decoder 322 decodes the DTMF tones. Likewise, if the keyboard 304 and/or computer mouse 306 input is encoded within a T.120 stream, input decoder 322 decodes the keyboard 304 and/or computer mouse 306 data from the T.120 stream. Extracting keyboard 304 and/or computer mouse 306 input from a multi-media communications session may involve converting the keyboard 304 and/or computer mouse 306 input into common formats for keyboard 304 and computer mouse 306 input.

After input decoder 322 extracts keyboard 304 and/or computer mouse 306 input from a multi-media communications session established with videoconferencing endpoint 302, input interpreter 324 parses and interprets the extracted input. In some cases, interpreting the keyboard 304 and/or computer mouse 306 input may involve identifying an application for which the keyboard 304 and/or computer mouse 306 input is intended. Such an application may be executing on computing device 312 itself or, alternatively, such an application may be executing on a different computing device, such as, for example, computing device 308 that is accessible to computing device 312 over network 314.

After input interpreter 324 has interpreted the extracted keyboard 304 and/or computer mouse 306 input, input handler 326 acts on the keyboard 304 and/or computer mouse 306 input in accordance with the interpretation provided by input interpreter 324. For example, if input interpreter 324 determines that the extracted keyboard 304 and/or computer mouse 306 input is intended as input to an application 310 executing on computing device 308, input handler 326 transmits the keyboard 304 and/or computer mouse 306 input to the corresponding application 310 executing on computing device 308 over network 314 using, for example, the TCP/IP communications protocol.

When output is received from an application 310 executing on computing device 308 (e.g., in response to input that was transmitted to application 310 executing on computing device 308 by input handler 326), output encoder 328 converts the output into a suitable format for transmitting to videoconferencing endpoint 302 (e.g., a video stream) and output transmitter 330 transmits the converted output received from application 310 to videoconferencing endpoint 302 within a multi-media communications session established with videoconferencing endpoint 302. Videoconferencing endpoint 302 receives such output from application 310 (e.g., in the form of a video stream) and displays the output at videoconferencing endpoint 302.

Other application(s) 320 enable computing device 312 to provide additional functionality. For example, in some implementations, the other application(s) 320 may enable computing device 312 to function as an MCU or other intermediary and/or coordinating computing device in a videoconferencing system. Other application(s) 320 may be implemented as instructions that are stored in a computer memory storage system and that are executable by processor(s) 316 to perform the functionality ascribed herein to the other application(s) 320.

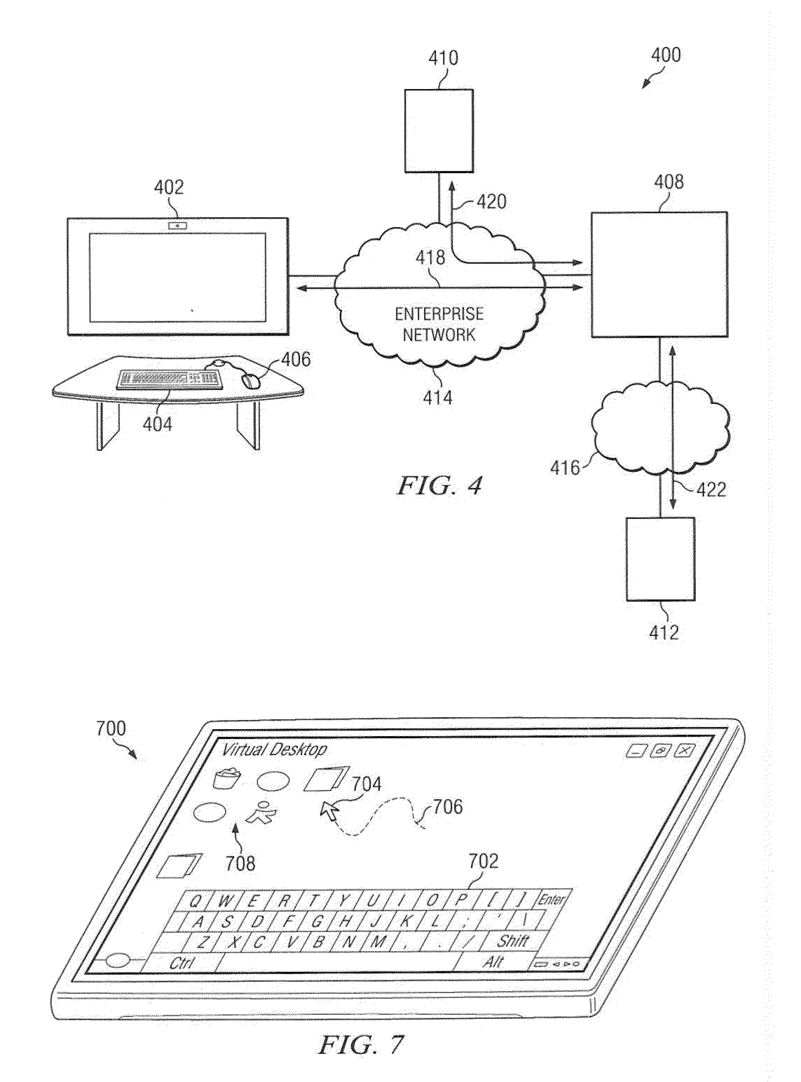

FIG. 4 is a diagram of an example of a communications system 400 that enables input received at a videoconferencing endpoint 402 from a keyboard 404 and/or computer mouse 406 to be communicated to remote computing devices 408, 410, and 412 as input to applications executing on the remote computing devices 408, 410, and 412 by incorporating the keyboard 404 and/or computer mouse 406 input into a multi-media communications session.

As illustrated in FIG. 4, communications system 400 includes a videoconferencing endpoint 402, such as, for example, a videoconferencing endpoint like the videoconferencing endpoint 100 illustrated in FIG. 1, and computing devices 408 and 410, all of which are communicatively coupled via an enterprise network 414. Enterprise network 414 may provide direct or indirect communication links between videoconferencing endpoint 402, computing device 408, and/or computing device 410 irrespective of physical separation between any of such devices. As such, videoconferencing endpoint 402 and computing devices 408 and 412 may be located in close geographic proximity to one another or, alternatively, videoconferencing endpoint 402 and computing devices 408 and 412 may be separated by vast geographic distances. Examples of enterprise network 414 include wide area networks (WANs), local area networks (LANs) including wireless LANs (WLANs), analog or digital wired and wireless telephone networks, radio, television, cable, satellite, any other delivery mechanisms for carrying data, and/or any combination thereof.

Communications system 400 also includes a computing device 412 that does not reside on enterprise network 414 but, instead, is accessible to computing device 408 via network 416. As such, in order for videoconferencing endpoint 402 and computing device 410 to communicate with computing device 412, videoconferencing endpoint 402 and computing device 412 may have to route communications to computing device 408 over enterprise network 414 so that computing device 408 can forward the communications along to computing device 412 over network 416.

Network 416 may provide direct or indirect communication links between computing device 408 and computing device 412 irrespective of physical separation between the two devices. As such, computing devices 408 and 412 may be located in close geographic proximity to one another or, alternatively, computing devices 408 and 412 may be separated by vast geographic distances. Examples of network 416 include the Internet, the World Wide Web, wide area networks (WANs), local area networks (LANs) including wireless LANs (WLANs), analog or digital wired and wireless telephone networks, radio, television, cable, satellite, any other delivery mechanisms for carrying data, and/or any combination thereof.

Videoconferencing endpoint 402 includes a keyboard 404 and a computer mouse 406 and is configured to establish a multi-media communications session 418 (e.g., an H.323 or SIP communications session) with computing device 408. In addition, videoconferencing endpoint 402 is configured to receive input from keyboard 404 and/or computer mouse 406 as input to applications executing on computing devices 408, 410, and 412 and to transmit such received keyboard 404 and/or computer mouse 406 input to computing device 408 by embedding the keyboard 404 and/or computer mouse 406 input within a multi-media communications session 418 (e.g., an H.323 or SIP communications session) established between videoconferencing endpoint 402 and computing device 408.

Computing device 408 is configured to receive such keyboard 404 and/or computer mouse 406 input from videoconferencing endpoint 402 within a multi-media communications session 418 with videoconferencing endpoint 402 and to identify an application for which the keyboard 404 and/or computer mouse 406 input is intended. If the received keyboard 404 and/or computer mouse 406 input is intended for an application executing on computing device 408, computing device 408 passes the keyboard 404 and/or computer mouse 406 input to the application executing on computing device 408. Alternatively, if computing device 408 determines that the received keyboard 404 and/or computer mouse 406 input is intended for an application executing on computing device 410, computing device 408 transmits the keyboard 404 and/or computer mouse 406 input to the application executing on computing device 410 via a communications session 420 established with computing device 410 over enterprise network 414. Similarly, if computing device 408 determines that the received keyboard 404 and/or computer mouse 406 input is intended for an application executing on computing device 412, computing device 408 transmits the keyboard 404 and/or computer mouse 406 input to the application executing on computing device 412 via a communications session 422 established with computing device 412 over enterprise network 416.

Computing device 408 also is configured to receive output from applications executing on computing devices 408, 410, and 412 that is intended for videoconferencing endpoint 402 and to transmit such output to videoconferencing endpoint 402. For example, if computing device 408 receives output from an application executing on computing device 408 that is intended for videoconferencing endpoint 402, computing device 408 converts the application output into a format (e.g., a video stream) that is suitable for transmitting to videoconferencing endpoint 402 and transmits the converted application output to videoconferencing endpoint 402 by incorporating the converted application output into the multi-media communications session 418 established with videoconferencing endpoint 402. Similarly, if computing device 408 receives output from an application executing on computing device 410 that is intended for videoconferencing endpoint 402 within communications session 420, computing device 408 converts the application output into a format (e.g., a video stream) that is suitable for transmitting to videoconferencing endpoint 402 and transmits the converted application output to videoconferencing endpoint 402 by incorporating the converted application output into the multi-media communications session 418 established with videoconferencing endpoint 402. Likewise, if computing device 408 receives output from an application executing on computing device 412 that is intended for videoconferencing endpoint 402 within communications session 422, computing device 408 converts the application output into a format (e.g., a video stream) that is suitable for transmitting to videoconferencing endpoint 402 and transmits the converted application output to videoconferencing endpoint 402 by incorporating the converted application output into the multi-media communications session 418 established with videoconferencing endpoint 402.

In this manner, videoconferencing endpoint 402 is enabled to provide keyboard 404 and/or computer mouse 406 input to and receive output from applications executing on computing devices that reside on the same enterprise network 414 as the videoconferencing endpoint 402 (e.g., computing devices 408 and 410) as well as to provide keyboard 404 and/or computer mouse 406 input to and receive output from applications executing on computing devices that reside off of the enterprise network 414.

In one implementation, the techniques described herein for incorporating keyboard and/or computer mouse input received at a videoconferencing endpoint into a multi-media communications session may be used to enable a user of a videoconferencing endpoint from one videoconferencing system to call a coordinating device (e.g., an MCU) for a different videoconferencing system and access one or more applications available from the coordinating device for the different videoconferencing system that the videoconferencing endpoint otherwise would not be able to access. For example, a first corporation may contract with one videoconferencing system provider to provide a videoconferencing solution for the first corporation, and a second corporation may contract with a different videoconferencing system provider to provide a videoconferencing system for the second corporation. Without more, a videoconferencing endpoint from one videoconferencing system may not be able to access management services (e.g., scheduling, user directory, and/or presence interfaces) provided by the other videoconferencing system. However, by enabling a videoconferencing endpoint from one system to incorporate keyboard and/or mouse data within a multi-media communications session established with a videoconferencing management device of the other videoconferencing system, it may be possible for a user of the videoconferencing endpoint to access management services offered by the videoconferencing management device of the other videoconferencing system.

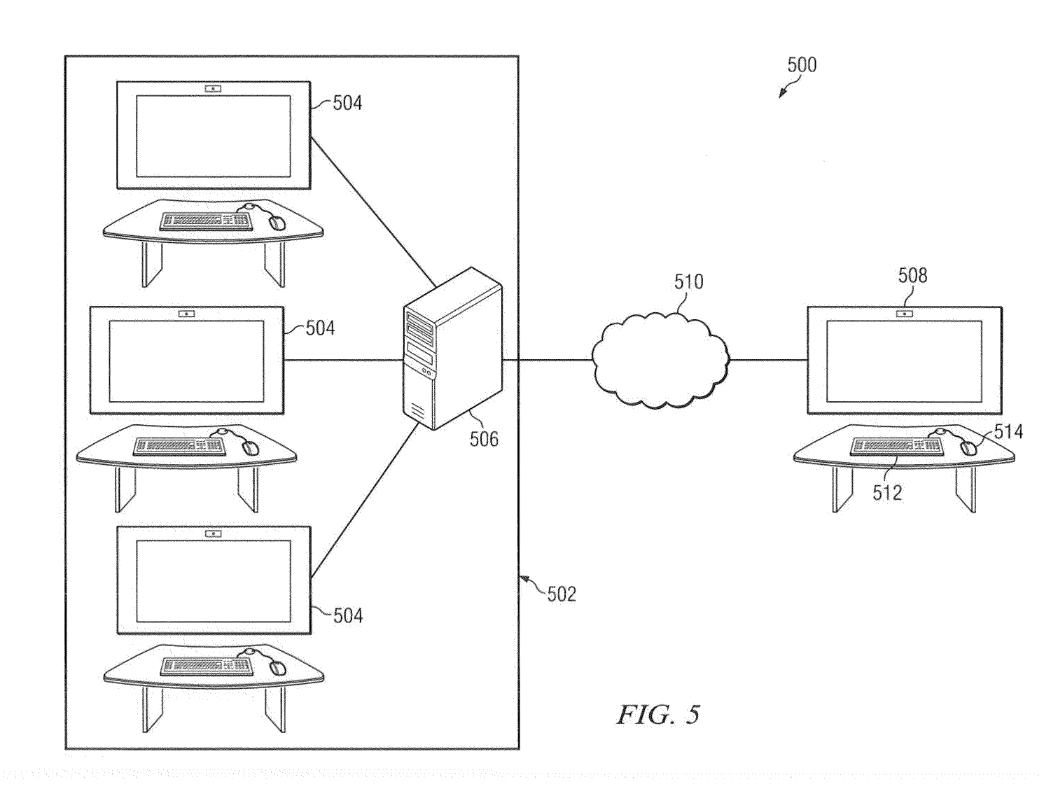

FIG. 5 is a diagram of an example of a communications system 500 that enables a videoconferencing endpoint from one videoconferencing system to access management services (e.g., scheduling, user directory, and/or presence monitoring interfaces) provided by a different videoconferencing system. As illustrated in FIG. 5, communications system 500 includes a first videoconferencing system 502 having videoconferencing endpoints 504 and a videoconferencing management system 506 (e.g., an MCU and/or a protocol gateway, for instance, configured to enable interoperability between different communications protocols like H.320 ISDN and H.323). In addition, communications system 500 includes a videoconferencing endpoint 508 belonging to a different videoconferencing system and a network 510 that communicatively couples the videoconferencing endpoint 508 to videoconferencing system 502.

Network 510 may provide direct or indirect communication links between videoconferencing endpoint 508 and videoconferencing system 502 irrespective of physical separation between the two devices. As such, videoconferencing endpoint 508 and videoconferencing system 502 may be located in close geographic proximity to one another or, alternatively, computing videoconferencing endpoint 508 and videoconferencing system 502 may be separated by vast geographic distances. Examples of network 510 include the Internet, the World Wide Web, wide area networks (WANs), local area networks (LANs) including wireless LANs (WLANs), analog or digital wired and wireless telephone networks, radio, television, cable, satellite, any other delivery mechanisms for carrying data, and/or any combination thereof.

Videoconferencing system 502 may be operated by or on behalf of an individual company or organization. Videoconferencing management system 506 provides management services for videoconferencing system 502. For example, videoconferencing management system 506 may operate as an MCU for videoconferencing system 502, coordinating multipoint videoconferences between the videoconference endpoints 504 of videoconferencing system 502. In addition, videoconferencing management system 506 may provide additional management services to videoconferencing system 502, such as, for example, access to an enterprise directory for the company or organization that operates videoconferencing system 502, a scheduling application for scheduling videoconferences using videoconferencing system 502, and/or a presence application that monitors the presence of videoconferencing participants within videoconferencing system 502.

Videoconferencing endpoint 508 includes keyboard 512 and computer mouse 514. In addition, videoconferencing endpoint 508 is configured to transmit input received from keyboard 512 and/or computer mouse 514 to applications executing on one or more remote computing devices by incorporating such input received from keyboard 512 and/or computer mouse 514 into multi-media communications sessions established with such other remote computing devices.

Like videoconferencing system 502, the videoconferencing system to which videoconferencing endpoint 508 belongs also may be operated by or on behalf of a company or organization. However, the company or organization that operates videoconferencing system 502 may be different from the company or organization that operates the videoconferencing system to which videoconferencing endpoint 508 belongs. Furthermore, videoconferencing system 502 may have been manufactured by one videoconferencing service provider while the videoconferencing system to which videoconferencing endpoint 508 belongs may have been manufactured by a different videoconferencing service provider. As a result, the videoconferencing endpoints 504 of videoconferencing system 502 may have access to different management services (e.g., the management services provided by videoconferencing management system 506) than the management services to which videoconferencing endpoint 508 has access.

However, employing techniques described herein, videoconferencing endpoint 508 may be able to access the management services provided to videoconferencing system 502 by videoconferencing management system 506. For example, videoconferencing endpoint 508 may call videoconferencing management system 506 over network 510 and establish a multi-media communications session (e.g., an H.323 or SIP communications session) with videoconferencing management system 506. Thereafter, output generated by the management services provided by videoconferencing management system 506 may be converted into a suitable format (e.g., a video stream) for transmission to videoconferencing endpoint 508 and transmitted to videoconferencing endpoint 508 within the established multi-media communications session between videoconferencing endpoint 508 and videoconferencing management system 506. In addition, videoconferencing endpoint 508 may enable a user of videoconferencing endpoint 508 to provide keyboard 512 and/or computer mouse 514 input to the management services provided by videoconferencing management system 506 by incorporating keyboard 512 and/or computer mouse 514 input received by videoconferencing endpoint 508 into the multi-media communications session established between videoconferencing endpoint 508 and the videoconferencing management system 506 of videoconferencing system 502. In this manner, videoconferencing endpoint 508 may be able to access the management services provided by videoconferencing management system 506, such as, for example, an enterprise directory for the company or organization that operates videoconferencing system 502, a scheduling application for scheduling videoconferences for videoconferencing system 502, and/or a presence application that monitors the presence of videoconferencing participants within videoconferencing system 502.

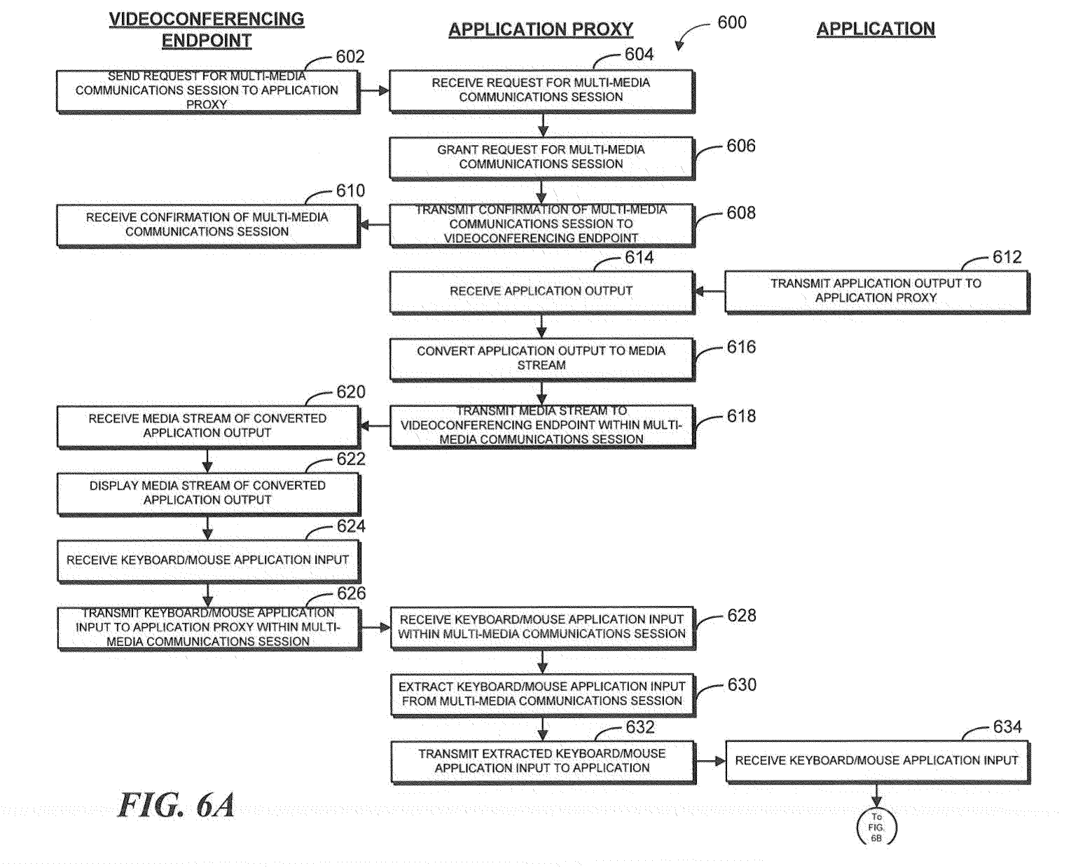

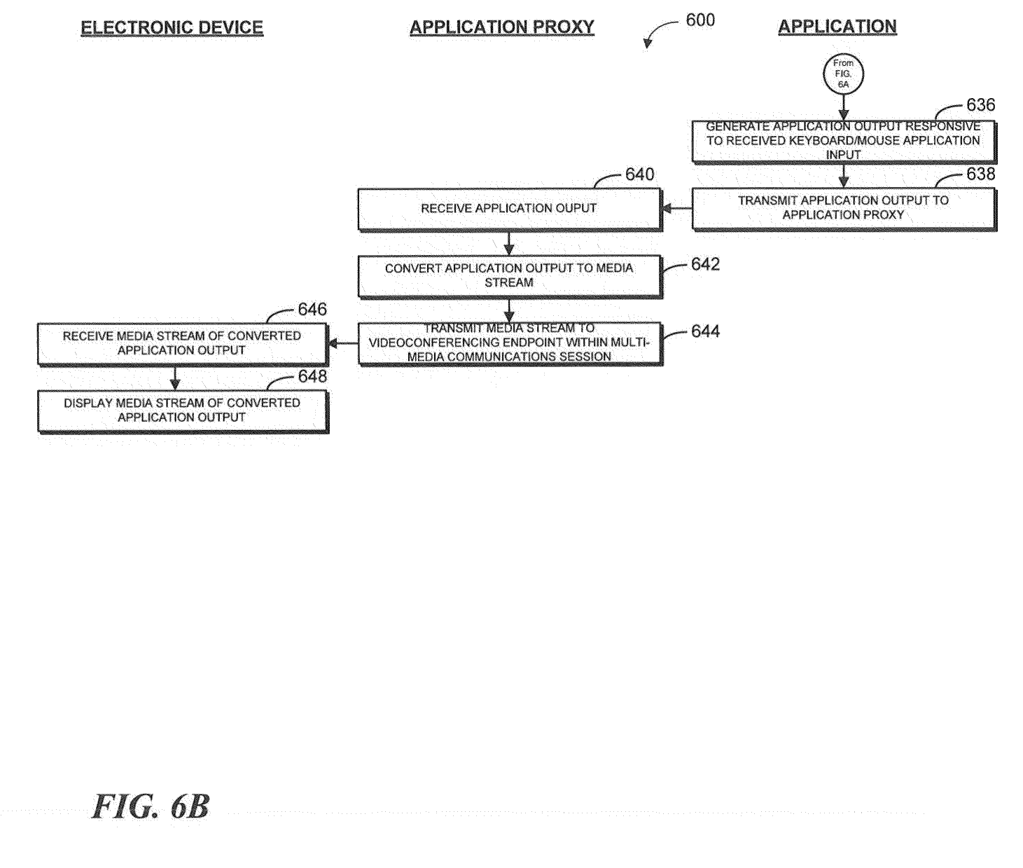

FIGS. 6A-6B illustrate a flow diagram 600 of an example of a process for exchanging application input/output within a multi-media communications session. The process illustrated in the flow diagram 600 of FIGS. 6A-6B may be performed by a videoconferencing endpoint, an application proxy (e.g., a server or other computing device), and an application executing on a computing device.

Initially, the videoconferencing endpoint calls the application proxy and sends a request to establish a multi-media communications session to the application proxy (602). For example, the videoconferencing endpoint may call the application proxy and request to establish a communications session with the application proxy according to the H.323 standard. Alternatively, the videoconferencing endpoint may call the application proxy and request to establish a communications session according to the SIP standard.

The application proxy receives the request to establish a multi-media communications session (e.g., an H.323 or SIP communications session) from the videoconferencing endpoint (604), and, in response, grants the request for the multi-media communications session (e.g., an H.323 or SIP communications session) with the videoconferencing endpoint (606). Thereafter, the application proxy transmits a confirmation of the multi-media communications session (e.g., an H.323 or SIP communications session) to the videoconferencing endpoint (608), which is received by the videoconferencing endpoint (610), thereby establishing the multi-media communications session (e.g., an H.323 or SIP communications session) between the videoconferencing endpoint and the application proxy.

Meanwhile, the application executing on the computing device transmits application output to the application proxy (612). For example, the application may transmit a GUI for interacting with the application to the application proxy. The application proxy receives the application output transmitted by the application (614) and converts the application output into a media stream for transmission to the videoconferencing endpoint within the multi-media communications session with the videoconferencing endpoint (616). The application proxy then transmits the media stream of converted application output to the videoconferencing endpoint within the multi-media communications session established between the videoconferencing endpoint and the application proxy (618). In the example where the application output is a GUI for interacting with the application, the application proxy transmits the GUI for interacting with the application to the videoconferencing endpoint as a video stream within the multi-media communications session with the videoconferencing endpoint.

The videoconferencing endpoint receives the media stream of converted application output from the application proxy within the multi-media communications session established between the videoconferencing endpoint and the application proxy (620) and displays the media stream of converted application output at the videoconferencing endpoint (622). In the example where the application output is a GUI for interacting with the application, the videoconferencing endpoint displays the GUI for interacting with the application as a video at the videoconferencing endpoint.

Responsive to the application output displayed at the videoconferencing endpoint, the videoconferencing endpoint receives keyboard and/or computer mouse application input (624). For example, when the application output displayed at the videoconferencing endpoint is a GUI for interacting with the application, keyboard and/or computer mouse input to the GUI for interacting with the application may be received at the videoconferencing endpoint. The videoconferencing endpoint then transmits the received keyboard and/or computer mouse input to the application proxy within the multi-media communications session established with the application. For example, when an H.323 communications session is established with the application proxy, the videoconferencing endpoint may encode the received keyboard and/or computer mouse application input into the video stream being transmitted within the H.323 communications session with the application proxy. Alternatively, the videoconferencing endpoint may encode the received keyboard and/or computer mouse application into a T.120 stream being transmitted within the H.323 communications session or the videoconferencing endpoint may map the keyboard and/or computer mouse application input onto DTMF tones that are transmitted to the application proxy as in-band or out-of-band signals within the H.323 communications session.

The application proxy receives the keyboard and/or computer mouse application input transmitted within the multi-media communications session (628) and extracts it from the multi-media communications session (630). For example, if the keyboard and/or computer mouse input is encoded within a video stream in the multi-media communications session, the application proxy decodes the keyboard and/or computer mouse input from the video stream. Similarly, if the keyboard and/or computer mouse input is encoded within a T.120 stream, the application proxy decodes the keyboard and/or computer mouse input from the T.120 stream. Likewise, if the keyboard and/or computer mouse input is transmitted as DTMF tones within the multi-media communications session, the application proxy decodes the keyboard and/or computer mouse input from the DTMF tones.

After extracting the keyboard and/or computer mouse input from the multi-media communications session, the application proxy transmits the keyboard and/or computer mouse input to the application (632). The application receives the keyboard and/or computer mouse input (634), acts on it, and generates application output that is responsive to the keyboard and/or computer mouse input (636). The application then transmits the application output to the application proxy (638).

When the application proxy receives the application output from the application (640), the application proxy converts the application output into a media stream for transmission to the videoconferencing endpoint within the multi-media communications session with the videoconferencing endpoint (642). The application proxy then transmits the media stream of converted application output to the videoconferencing endpoint within the multi-media communications session established between the videoconferencing endpoint and the application proxy (644). The videoconferencing endpoint then receives the media stream of converted application output from the application proxy within the multi-media communications session established between the videoconferencing endpoint and the application proxy (646), and displays the media stream of converted application output at the videoconferencing endpoint (648).

In this manner, the videoconferencing endpoint is able to access and interact with an application executing on a remote computing device by transmitting input to and receiving output from the application that is embedded within a multi-media communications session.

The techniques for incorporating keyboard and/or computer mouse data into a multi-media communications session (e.g., an H.323 or SIP communications session) described herein are not limited to keyboard and/or computer mouse data received at a videoconferencing endpoint. Rather, they may be extended to a number of different applications involving any type of computing device. For example, a multi-media communications session (e.g., an H.323 or SIP communications session) may be established between any two different computing systems, and keyboard and/or computer mouse input received at one such computing device may be transmitted to an application executing on the other such device by incorporating the keyboard and/or computer mouse input into the multi-media communications session established between the two computing devices.

For example, in one implementation, a multi-media communications session may be established between a tablet computer and a server on which a remote desktop application that provides access to other applications at the server is executing. The server then may transmit output generated by the remote desktop application, such as, for example, a GUI for interacting with the remote desktop application, to the tablet computer by incorporating the output within the multi-media communications session with the tablet computer, for example as a video stream. The tablet computer then may display output generated by the remote desktop application and enable a user of the tablet computer to provide input to the remote desktop application by manipulating a keyboard and/or a computer mouse control at the tablet computer. The tablet computer then may transmit any such keyboard and/or computer mouse input for the remote desktop application received at the tablet computer to the server by incorporating the keyboard and/or computer mouse input into the multi-media communications session with the server. In this manner, a desktop computing environment may be made available at the tablet computer even if the tablet computer itself is not configured to provide a desktop computing environment.

FIG. 7 is a diagram of an example of a tablet computer 700 accessing a remote desktop application made available by another computing device (not shown) through a multi-media communications session (e.g., an H.323 or SIP multi-media communications session). Tablet computer 700 employs touchscreen technology that enables a user to provide input to the tablet computer 700 by touching or hovering over the touchscreen device with a finger, stylus, or other input mechanism. In addition, tablet computer 700 provides a softkey keyboard 702 that enables a user of tablet computer 700 to provide keyboard input to the tablet computer by using the touchscreen technology to select desired keys on the softkey keyboard 702. Tablet computer 700 also provides a computer mouse control 704 that enables a user to provide computer mouse input to tablet computer 700 by using the touchscreen technology to trace paths 706 across the touchscreen.

Tablet computer 700 also is configured to establish a multi-media communications session (e.g., an H.323 or SIP communications session) with another computing device (e.g., a server) (not shown) on which a remote desktop application is executing that provides access to one or more applications at the other computing device. The other computing device is configured to convert output from the remote desktop application, such as, for example, a GUI for interacting with the remote desktop application, into a video stream for transmission to the tablet computer 700 within the multi-media communications session established with the tablet computer 700. Tablet computer 700 itself is configured to display video streams it receives from the other computer within the multi-media communications session established with the other computing device. Therefore, when the other computing device transmits the GUI for interacting with the remote desktop application to tablet computer 700 as a video stream within the multimedia communications session established with tablet computer 700, tablet computer 700 displays the GUI 708.

Tablet computer 700 also is configured to transmit keyboard 702 and/or computer mouse 704 input received by tablet computer to the other computing device as input to the remote desktop application by incorporating the keyboard 702 and/or computer mouse 704 input within the multi-media communications session with the other computer. In this manner, a desktop computing environment may be made available at the tablet computer 700 even if the tablet computer 700 itself is not configured to provide a desktop computing environment.

A number of methods, techniques, systems, and apparatuses have been described. However, additional variations are possible. For example, although techniques for transmitting input from one device to another physically distinct device by incorporating such input within a communications protocol for transmitting video (or audio-video) are described generally herein in the context of transmitting keyboard and/or computer mouse input from one device to another physically distinct device, these techniques can be used equally well to exchange input/output from a any number of different types of devices including, for example, scanners, fax machines, printers, and teletype devices. Additionally or alternatively, in the case of a videoconferencing endpoint that transmits keyboard and/or computer mouse input upstream to a remote and physically distinct computing device by incorporating such keyboard and/or computer mouse input within a media stream and/or communications protocol for transmitting video (or audio-video), loopback or local caching techniques may be employed at the videoconferencing endpoint for the purpose of mitigating delay that otherwise might be perceived by a user of the videoconferencing endpoint. For example, when a user of the videoconferencing endpoint uses a computer mouse to move a pointer around an interface displayed by the display at the videoconferencing endpoint, loopback or local caching techniques may be employed at the videoconferencing endpoint to display movements of the pointer (e.g., via overlay or compositing techniques) so that the user is provided with nearly instantaneous feedback responsive to movements of the keyboard mouse. Similarly, when a user of the videoconferencing endpoint uses a keyboard to enter text into an interface displayed by the display at the videoconferencing endpoint, loopback or local caching techniques may be employed at the videoconferencing endpoint to display the text (e.g., via overlay or compositing techniques) so that the user is provided with nearly instantaneous feedback responsive to the user's keystrokes.

The described methods, techniques, systems, and apparatuses may be implemented in digital electronic circuitry or computer hardware, for example, by executing instructions stored in computer-readable storage media. Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order, in some implementations, individual operations may be rearranged in a different order and/or eliminated and the desired results still may be achieved. Similarly, components in the disclosed systems may be combined in a different manner and/or replaced or supplemented by other components and the desired results still may be achieved.

What is claimed is:

1. A computer-implemented method comprising:
establishing, between a first computing system and a second computing system, a communications session according to a communications protocol that enables exchange of video content between systems, the second computing system being physically distinct and remote from the first computing system;
receiving, at the second computing system and within the established communications session, data from the first computing system, the received data including application input;
extracting the application input from the received data;
passing the extracted application input to an application;
receiving, from the application to which the extracted application input was passed, application output, the application output being responsive to the passed application input; and
transmitting, from the second computing system to the first computing system and within the established communications session, at least some of the application output as video content.

2. The method of claim 1 wherein the communications protocol enables exchange of video content and audio content such that establishing a communications session between the first computing system and the second computing system includes establishing a communications session between the first computing system and the second computing system according to a communications protocol that enables exchange of video content and audio content.

3. The method of claim 2 wherein establishing a communications session between the first computing system and the second computing system according to a communications protocol that enables exchange of video content and audio content includes establishing an H.323 communications session between the first computing system and the second computing system such that:
receiving data, including application input, from the first computing system at the second computing system and within the established communications session includes receiving data, including application input, from the first computing system at the second computing system within the established H.323 communications session; and
transmitting at least some of the application output as video content from the second computing system to the first computing system within the established communications session includes transmitting at least some of the application output as video content from the second computing system to the first computing system within the established H.323 communications session.

4. The method of claim 3 wherein:
receiving data, including application input, from the first computing system at the second computing system and within the established H.323 communications session includes receiving data, including input from a keyboard, from the first computing system at the second computing system and within the established H.323 communications session;
extracting the application input from the received data includes extracting the input from the keyboard from the data received within the established H.323 communications session;
passing the extracted application input to the application includes passing the extracted input from the keyboard to the application; and
receiving application output that is responsive to the passed application input includes receiving application output that is responsive to the passed input from the keyboard.

5. The method of claim 3 wherein:
receiving data, including application input, from the first computing system at the second computing system and within the established H.323 communications session includes receiving data, including input from a pointing device, from the first computing system at the second computing system and within established the H.323 communications session;
extracting the application input from the received data includes extracting the input from the pointing device from the data received within the established H.323 communications session;
passing the extracted application input to the application includes passing the extracted input from the pointing device to the application; and
receiving application output that is responsive to the passed application input includes receiving application output that is responsive to the passed input from the pointing device.

6. The method of claim 5 wherein the pointing device is a computer mouse such that:
receiving data, including input from a pointing device, from the first computing system at the second computing system and within the established H.323 communications session includes receiving data, including input from a computer mouse, from the first computing system and the second computing system and within the established H.323 communications session;
extracting the input from the pointing device from the data received within the established H.323 communications session includes extracting the input from the computer mouse from the data received within the established H.323 communications session;
passing the extracted input from the pointing device to the application includes passing the extracted input from the computer mouse to the application; and
receiving application output that is responsive to the passed input from the pointing device includes receiving application output that is responsive to the passed input from the computer mouse.

7. The method of claim 3 wherein receiving data, including application input, from the first computing system at the second computing system and within the established H.323 communications session includes receiving audio-video (A/V) content and application input from the first computing system at the second computing system within the established H.323 communications session.

8. The method of claim 7 wherein:
receiving A/V content and application input from the first computing system at the second computing system within the established H.323 communications session includes receiving an audio signal and a corresponding video signal, with the application input being embedded within the video signal, within the established H.323 communications session; and
extracting the application input from the received data includes extracting the application input from the video signal.

9. The method of claim 7 wherein:
receiving A/V content and application input from the first computing system at the second computing system within the established H.323 communications session includes receiving a T.120 stream, with the application input being embedded within the T.120 stream, within the established H.323 communications session; and
extracting the application input from the received data includes extracting the application input from the T.120 stream.

10. The method of claim 7 wherein:
receiving A/V content and application input from the first computing system at the second computing system within the established H.323 communications session includes receiving dual-tone multi-frequency (DTMF) tones onto which the application input has been mapped in-band with the A/V content within the established H.323 communications session; and
extracting the application input from the received data includes converting the received DTMF tones into the application input.

11. The method of claim 7 wherein:
establishing an H.323 communications session between the first computing system and the second computing system includes establishing first and second channels between the first computing system and the second computing system within the H.323 communications session;
receiving A/V content and application input from the first computing system at the second computing system within the established H.323 communications session:
receiving A/V content from the first computing system at the second computing system over the first channel within the established H.323 communications session, and
receiving dual-tone multi-frequency (DTMF) tones onto which the application input has been mapped from the first computing system at the second computing system over the second channel within the established H.323 communications session; and
extracting the application input from the received data includes converting the received DTMF tones into the application input.

12. The method of claim 2 wherein establishing a communications session between the first computing system and the second computing system according to a communications protocol that enables exchange of video content and audio content includes establishing a session initiation protocol (SIP) communications session between the first computing system and the second computing system such that:
receiving data, including application input, from the first computing system at the second computing system within the established communications session includes receiving data, including application input, from the first computing system and the second computing system within the SIP communications session; and
transmitting at least some of the application output as video content from the second computing system to the first computing system within the established communications session includes transmitting at least some of the application output as video content from the second computing system to the first computing system within the SIP communications session.

13. The method of claim 1 wherein receiving data, including application input, from the first computing system at the second computing system and within the established communications session includes receiving data of a first content type and application input that is of a second content type that is different from the first content type from the first computing system at the second computing system and within the established communications session.

14. A system comprising:
one or more processing elements; and
a computer memory storage component storing instructions that, when executed by the one or more processing elements, cause the one or more processing elements to:
receive, from a physically distinct electronic device and over a first network connection to the electronic device, a request to establish a communications session according to a communications protocol that enables the exchange of audio-video (A/V) content;
responsive to receiving the request to establish a communications session, establishing a communications session with the electronic device over the first network connection to the electronic device according to the communications protocol that enables the exchange of A/V content;
receive data from the electronic device over the first network connection to the electronic device within the established communications session with the electronic device, the received data including application input signals from a keyboard;
extract the application input signals from the keyboard from the received data;
determine that the extracted application input signals from the keyboard correspond to an application hosted by a physically distinct computing system, the computing system being different from the electronic device;
as a consequence of having determined that the extracted application input signals from the keyboard correspond to the application hosted by computing system, transmit the extracted application input signals from the keyboard to the computing system over a second network connection to the computing system, the first network connection being different from the second network connection;
receive application output that is responsive to the transmitted application input signals from the keyboard from the application hosted by the computing system over the second network connection to the computing system;
convert the received application output into a video stream; and
transmit the converted application output in the form of the video stream to the electronic device over the first network connection to the electronic device within the established communications session with the electronic device.

15. A computer-readable storage medium storing instructions that, when executed by a processor, cause a processor to:
access a graphical user interface that enables interaction with a computing system;
generate a video stream representation of the graphical user interface;
transmit the video stream representation of the graphical user interface from the computing system to an electronic device that is physically distinct from the computing system;
receive, at the computing system and from the electronic device, a media stream having embedded therein user input received from at least one of a keyboard communicatively coupled to the electronic device and a computer mouse communicatively coupled to the electronic device;
extract the user input from the received media stream;
provide the extracted user input to the computing system as input;
modify the video stream representation of the graphical user interface to reflect a change to the graphical user interface that resulted from the user input being provided to the computing system as input; and
transmit the modified video stream representation of the graphical user interface reflecting the change to the graphical user interface to the electronic device.
